(19) United States
(12) Patent Application Publication
(10) Pub. No.: US 2005/0216913 A1
(43) Pub. Date: Sep. 29, 2005

(54) Annotating / rating / organizing / relating content rendered on computer device during idle mode thereof

(76) Inventors: David James Gemmell, Danville, CA (US); Roger Lueder, San Francisco, CA (US); Gordon Bell, San Francisco, CA (US)

Correspondence Address: WOODCOCK WASHBURN LLP, ONE LIBERTY PLACE - 46TH FLOOR, PHILADELPHIA, PA, 19103, US

(21) Appl. No.: 10/806,506

(22) Filed: Mar. 23, 2004

(51) Int. Cl. G06F 9/46

(52) U.S. Cl. 718/100

(57) ABSTRACT

An idle mode on a computing device presents personal digital content on the computing device in a passive manner to an individual and allows the individual to manage the presented content. Upon being initiated, the idle mode selects a collection of content to be serially presented, orders the selected collection of content based on an ordering criteria, and presents each piece of content in the collection in order for a predetermined period of time. During the presenting of each piece of content in the collection, the idle mode awaits a trigger from the individual at the computing device corresponding to an active form of managing the piece of content, and upon receiving such trigger from the individual, receives actively collected information corresponding to the trigger from the individual and stores the actively collected information.

### TECHNICAL FIELD

The present invention relates to content rendered on a computing device such as content displayed on a screen and/or auralized through a speaker, and methods of annotating, rating, organizing, and relating the rendered content and the like. More particularly, the present invention relates to such content being rendered during an idle mode where the computing device is not otherwise actively employed by a user, and such annotating, rating, organizing, and relating and the like taking place during such idle mode.

### BACKGROUND OF THE INVENTION

It is to be appreciated that with the increasing capacity of memory available on a computing device, particularly hard disk space but not limited thereto, and with the increasing amount of available personal digital content such as pictures that may be obtained from digital cameras, movies that maybe obtained from digital camcorders, digital media on CDs and DVDs and the like, and the like, a user of such a computing device can and likely will collect and store in such memory on such computing device large amounts of such personal digital content. Note, though, that inasmuch as a typical computing device will have vast amounts of storage and a typical user will have a very large personal collection of content, it likely will become too burdensome for the user to organize, manage, and categorize all of such content in an orderly and purposeful manner. Correspondingly, it likely will become too burdensome for the user to even browse through the amassed personal digital content.

Quite simply, as the amount of personal digital content of a user increases, it is less likely that the user can manage such content, let alone review and enjoy such content in any coherent fashion. Instead, the content becomes a disorganized mass of confusion within which the user can wade into only at his or her own peril. Moreover, beyond some point, it may even be the case that the user gives up on ever being able to review and enjoy the content, and instead the user may ignore that the content exists or may even permanently delete such content in frustration. This may be true despite the fact that the personal digital content of the user could be highly valuable to the user if only such content was organized, managed, and categorized in some orderly and purposeful manner.

It is to be appreciated that a typical computing device such as a personal computer or the like includes an idle mode, whereby the computing device upon a period of inactivity goes into such idle mode and therein renders predetermined content. Such content may for example include video and/or fixed pictures to be displayed on a screen of the computing device, audio to be auralized through a speaker of the computing device, and/or the like. Such idle mode has historically been termed a ‘screensaver’ for the reason that the original purpose of the idle mode was to prevent damage to the screen from phosphorescent burn-in, which could occur should enough time elapse without the image on the screen changing. However, such phosphorescent burn-in is no longer an issue for the vast majority of screens, and such screensaver or idle mode (hereinafter ‘idle mode’) is now mainly for the amusement and entertainment of any individual who may happen to look at the screen, listen to the speakers, and/or the like.

More to the point, however, it would be useful to take advantage of some form of idle mode in a computing device having personal digital content of a user thereon to present such personal content such that the user can if he or she so chooses review the content in a generally passive manner, i.e. without any real effort on the part of such user. Moreover, it would be useful to allow the user when reviewing the content during the idle mode to organize, manage, and categorize such content, again if he or she so chooses. Thus, the user is relieved from the burden of having to actively search for and review the content, and instead can both enjoy the content as it is passively presented and also organize, manage, and categorize such content.

Accordingly, a need exists for a computing device having an idle mode that passively presents personal digital content of a user thereto. Also, a need exists for such an idle mode where the user upon reviewing the content can organize, manage, and categorize same. Further, a need exists for the idle mode where the user can annotate, rate, organize, and relate the content as presented. Thus, the content can over time be converted into a highly useful form such that the user can actively and/or passively review same in a more efficient, convenient, and directed manner, and thereby can value the content more highly.

### SUMMARY OF THE INVENTION

The aforementioned needs are satisfied at least in part by the present invention in which a system and method are provided to implement an idle mode on a computing device. The idle mode presents personal digital content on the computing device in a passive manner to an individual and allows the individual to manage the presented content. Upon being initiated, the idle mode selects a collection of content to be serially presented, orders the selected collection of content based on an ordering criteria, and presents each piece of content in the collection in order for a predetermined period of time.

During the presenting of each piece of content in the collection, the idle mode awaits a trigger from the individual at the computing device corresponding to an active form of managing the piece of content, and upon receiving such trigger from the individual, receives actively collected information corresponding to the trigger from the individual and stores the actively collected information.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a general purpose computer system in which aspects of the present invention and/or portions thereof may be incorporated;

FIG. 2 is a block diagram showing a computing device including an idle mode in accordance with one embodiment of the present invention; and

FIG. 3 is a flow diagram showing key steps performed by and in connection with the idle mode of FIG. 2 in accordance with one embodiment of the present invention.

### DETAILED DESCRIPTION OF THE INVENTION

Computer Environment

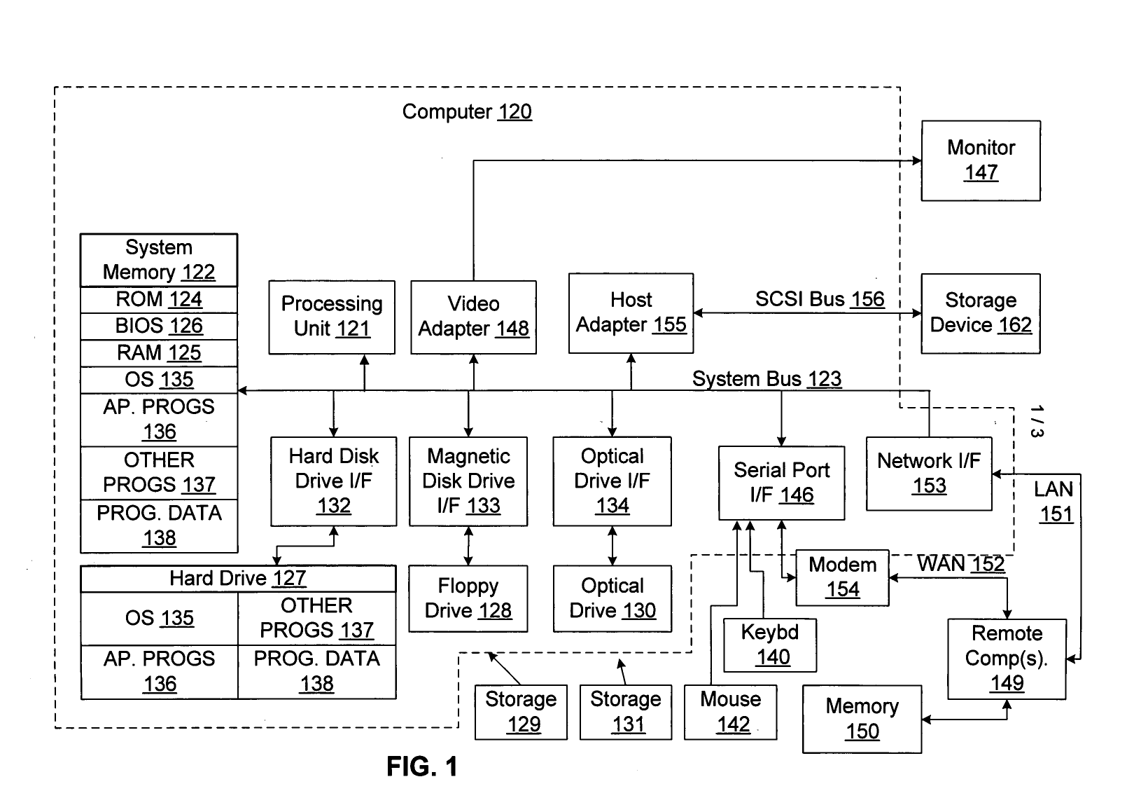

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 20.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

Idle Mode Annotating/Rating/Organizing/Relating

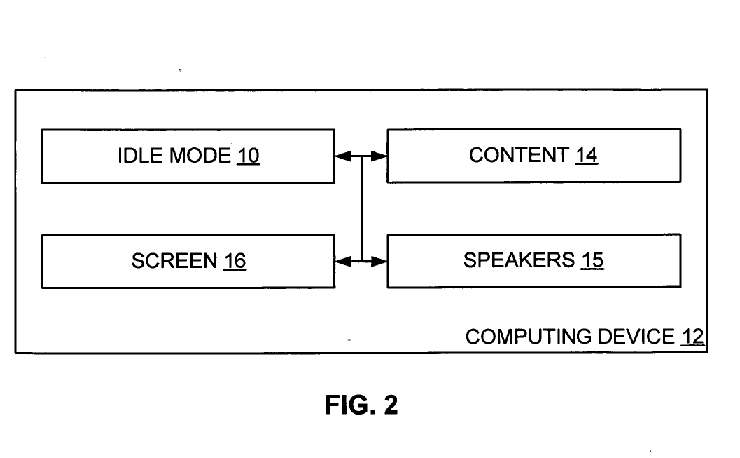

In the present invention, and turning now to FIG. 2, an idle mode 10 of a computing device 12 such as a personal computer or the like is employed to present personal digital content 14 of a user in a passive manner, i.e., without the necessary input of such user.

As was set forth above, the idle mode 10 may indeed be in the form of a ‘screensaver’ that is initiated on the computing device 12 after some period of inactivity, although other forms of idle mode 10 may be employed without departing from the spirit and scope of the present invention. As may be appreciated, the details of such an idle mode 10 and the presentation of content 14 during such idle mode 10 are known or should be apparent to the relevant public and therefore need not be set forth herein in any detail.

Note that the personal digital content 14 presented by the idle mode 10 may be any appropriate content 14 without departing from the spirit and scope of the present invention, presuming of course that the idle mode 10 and the computing device 12 are capable of rendering such content 14 during the presentation thereof. For example, the content 14 may comprise still pictures, motion picture with or without sound, a multimedia presentation including some combination of audio, motion pictures, and still pictures, and the like. Presumably, such content 14 may include digital photographs and/or movies taken by or on behalf of the user; sounds and/or musical pieces recorded by or on behalf of the user; photographic, audio, and/or video content 14 obtained from external sources by or on behalf of the user; and the like, all of which are stored on the computing device 12 in an appropriate location thereof, such as on a hard drive and in a particular branch of an organizing tree or sub-directory of a file system.

Note that such content 14 as stored on the computing device 12 may or may not already be organized, managed, and categorized. Instead, it may be the case that the content 14 is merely dumped into a particular area of the computing device 12 in an unorganized fashion, or may even be spread across multiple areas of the computing device 12 in some level of organization or with no organization.

As should be appreciated, in the course of the idle mode 10 operating, pieces of content 14 on the computing device 12 are retrieved therefrom and each retrieved piece of content 14 is appropriately serially presented or rendered. For example, if a piece of audio content 14 is retrieved, such audio content 14 is auralized through speakers 15, and likewise if a piece of picture content 14 is retrieved, such picture content 14 is displayed on a screen 16. Such content 14 may be retrieved by the idle mode 10 in any fashion without departing from the spirit and scope of the present invention. For example, the content 14 may be retrieved in a random or pseudo-random manner or may be retrieved in an ordered manner based on location, type, size, creation date, or the like.

The idle mode 10 may render each piece of retrieved content 14 in full or in part and for any particular temporal length without departing from the spirit and scope of the present invention. For example, if a picture, the content 14 may be rendered on the screen 16 in an original or reduced resolution, perhaps for two to five seconds. Correspondingly, if a video, the content 14 may be rendered with the picture in an original resolution but with the sound rendered on the speakers 15 in a simplified and reduced format, and for ten to fifteen seconds or else a percentage of the entire length, starting from the beginning or a random point in the middle. Presumably, upon finishing presenting one piece of content 14, another piece of content 14 is then rendered, and another, ad infinitum, until a user causes the computing device 12 to end the idle mode 10.

Significantly, and in one embodiment of the present invention, while the idle mode 10 is in operation, a user reviewing presented content 14 annotate such content 14 with text, audio, video, or the like, may rate such content 14 in the context of some predetermined rating system, may organize such content 14 into some orderly form along with other content 14, and/or may relate such content 14 by creating associations between the content 14 and other information stored on the computing device 12 or elsewhere. Note that in the course of the user annotating/rating/organizing/relating content 14, the idle mode 10 should pause or otherwise hold the content 14 until the user is finished. Thus, if video, continued rendering of the content 14 may be halted while a frozen image is displayed, and if pictorial, advancement to the next piece of content 14 is halted.

Note too that in a typical idle mode 10, the idle mode 10 is discontinued upon the user entering any of several inputs such as keystrokes on a keyboard, mouse movements on a mouse, and the like. As should be appreciated, however, such inputs should not stop the idle mode 10 of the computing device 12 of the present invention if such inputs are for purposes of entering the aforementioned annotations/rating/organizations/relations. Accordingly, and in one embodiment of the present invention, the idle mode 10 defines one or more non-discontinuing inputs that trigger entry of the aforementioned annotations/ratings/organizations/relations but that do not trigger discontinuance of the idle mode 10.

Thus, it may be that for a user to enter an annotation such user must first type a first predetermined key command, while for the user to enter a rating such user must first type a second predetermined key command, and the like. Note that the command or ‘trigger’ need not necessarily be a key command, but could instead be any other type of recognizable input without departing from the spirit and scope of the present invention. For example, the trigger could be a particular key sequence, a particular mouse movement or sequence of movements, a pressing of a particular mouse button or specialized keyboard button, a particular tap on the screen 16 if such screen 16 can directly receive and recognize inputs, a particular voice command if the computing device 12 can receive and recognize voice inputs, and the like.

It may even be the case that the trigger is passively received from a user or other person in the vicinity of the computing device 12, such as for example where the computing device 12 awaits a user or other person in the vicinity to say a particular audible phrase or make a particular visual gesture and then reacts to the phrase or gesture by ascertaining an annotation or rating therefrom. Thus, it may be that when presenting a piece of content 14 and hearing the phrase ‘I like that’, the idle mode 10 may increment a rating value associated with the piece of content 14. Moreover, if the voice is recognized as belonging to a particular individual, the idle mode 10 may in addition or in the alternative annotate the piece of content 14 with a note that the recognized individual said the phrase at a particular date and time. Correspondingly, it may be that when presenting the piece of content 14 and perceiving a user grimacing in response thereto, the idle mode 10 may reduce the rating value associated with the piece of content 14. Moreover, if the grimacing user is recognized as a particular individual, the idle mode 10 may in addition or in the alternative annotate the piece of content 14 with a note that the recognized individual grimaced at a particular date and time.

Following are several types of information a user may enter in connection with the idle mode 10 of the present invention:

Text annotation: Upon triggering in connection with a presented piece of content 14, a user types or otherwise enters text to annotate the piece of content 14, perhaps by way of a displayed pop-up dialog box or directly over the piece of content 14 on the screen 16. Of course, the text may be any sort of text without departing from the spirit and scope of the present invention.

Audio annotation: Upon triggering in connection with a presented piece of content 14, a user speaks or otherwise creates an audible message to annotate the piece of content 14, presumably by way of a microphone or the like. Of course, the message may be any sort of message without departing from the spirit and scope of the present invention. More than minimal pauses may be auto-removed, auto-gain and background noise removal may also be employed, and a display of the audio level can be presented to the user.

Audio-video annotation: Upon triggering in connection with a presented piece of content 14, a user records an audio-visual message to annotate the piece of content 14, presumably by way of a video camera and microphone or the like. Here again, the message may be any sort of message without departing from the spirit and scope of the present invention.

Active Ratings: Upon triggering in connection with a piece of content 14, a user can enter a rating for the content 14. The rating can be of an incremental or decremental nature, or can be directly entered as a number, letter, series of stars, the like. For incremental/decremental rating, the user enters a signal that either increases or decreases the rating, and the idle mode 10 may in response show the updated rating. For example, pressing an up arrow key increases the rating by some amount, and pressing a down arrow would similarly decrease the rating. The updated rating can be displayed as a numeric or pictorial representation or the like. In addition to keyboard entry, the rating may be entered visually by an appropriate gesture such as a thumbs up or thumbs down, orally by appropriate spoken terminology such as ‘good’, ‘bad’, etc., and the like. For directly entered rating, an appropriate user interface may be presented by which the user can set an appropriate value.

Passive Ratings: Even if a user never chooses to actively rate a piece of content 14, a rating may nevertheless be derived based on other actions the user takes with regard to such piece of content 14. For example, the idle mode 10 may derive a rating from the content 14 of an annotation for the piece of content 14, or even from a user actively annotating the piece of content 14. In the former case, the idle mode 10 may look for certain text or spoken terms such as ‘great’, ‘good’ ‘fun’, ‘bad’, ‘awful’, negatives thereof, and the like, or visual signals such as frowns, smiles, grimaces, and the like, and based thereon ascribe a rating for the piece of content 14. In the latter case, the idle mode 10 may presume that a piece of content 14 deserves a positive rating based on the fact that the user bothers to annotate such piece of content 14, and/or that a piece of content 14 deserves a negative rating based on the fact that the user does not bother to annotate such piece of content 14. Such passive ratings may also be similarly derived from other actions a user actively takes with regard to a piece of content 14, such as the organizing and relating actions set forth below.

Organization/classification: Upon triggering in connection with a presented piece of content 14, a user enters information necessary to organize the piece of content 14 on the computing device 12 or elsewhere, perhaps by way of a displayed pop-up dialog box or directly over the piece of content 14 on the screen 16. Note that such information may be entered by way of a keyboard and a mouse, by way of oral instructions, by way of visual instructions, or the like. Note, too, that such organization may be folder- and sub-folder-based or may be directed-graph-based. In the former case, the piece of content 14 is placed into a particular folder or sub-folder of a directory system, such as for example with other pieces of content 14 from a particular summer vacation. In the latter, the piece of content 14 is referenced to be accessible from one or more nodes, such as for example from one node representing the particular summer vacation and also from another node representing content 14 that is especially prized.

Active relating: Upon triggering in connection with a presented piece of content 14, a user enters information necessary to relate the piece of content 14 to other information stored on the computing device 12 or elsewhere, again perhaps by way of a displayed pop-up dialog box or directly over the piece of content 14 on the screen 16. Note again that such information may be entered by way of a keyboard and a mouse, by way of oral instructions, by way of visual instructions, or the like. Note, too, that such relating can be with regard to any type of information without departing from the spirit and scope of the present invention. For example, relating may be with regard to other pieces of content 14, with regard to applications. Relating may also be with regard to information such as may be organized into a database, such as for example information in a database about each person that appears in the piece of content 14, information in a database about where the piece of content 14 was created or where the piece of content 14 is ascribed to represent, information in a database about a time when the piece of content 14 was created or when the piece of content 14 is ascribed to represent, information in a database about what is shown or represented in the piece of content 14 or what is ascribed to be shown or represented, information in a database about why the piece of content 14 is on the computing device 12, information of a technical nature describing how the piece of content 14 was created, and the like. In short, such information that the piece of content 14 is related to may be any appropriate information without departing from the spirit and scope of the present invention.

Likewise, the database within which such information resides may also be any database without departing from the spirit and scope of the present invention. For example, the database may be associated with a personal organizational system that maintains calendar information for the user, personal information for individuals known to the user, business information for businesses known to the user, membership information on memberships of the user, and the like. In such situation, and as should now be appreciated, it may be the case that a piece of information could be related to a date or series of dates in the calendar information, a person or number of people in the personal information, a business or number of businesses in the business information, a membership or number of memberships in the membership information, and the like. As should be appreciated, such relating may be achieved by placing a reference to the piece of content 14 such as a pointer in the related-to information such that upon reviewing such related-to information the piece of content 14 may be accessed, and/or by placing a reference to the related-to information such as another pointer in the piece of content 14 such that upon reviewing such piece of content 14 the related-to information may be accessed.

Passive relating: Even without the user actively relating a piece of content 14 to other information stored on the computing device 12 or elsewhere, the idle mode 10 may itself perform such relating based on information available to and/or recognizable by the idle mode 10. For one example, the idle mode 10 may identify an individual in a first piece of information based on a relation of that individual to a second piece of content 14 and thereafter construct a relation between the individual and the first piece of content 14. Such identification can occur by the idle mode 10 employing any appropriate identification technique without departing from the spirit and scope of the present invention. Thus, the user may have already identified a first picture as being of a particular individual by an appropriately created relation, and the idle mode 10 may recognize the particular individual in a second picture and on its own create another appropriate relation therebetween. For another example, the idle mode 10 may on its own determine the creation date of a piece of information and thereafter construct a relation between the piece of content 14 and calendar information relating to such creation date. Of course, other types of passive relating may also be implemented in connection with the idle mode 10 without departing from the spirit and scope of the present invention.

Note that upon collecting information such as annotations, ratings, organizations, relations, and the like in connection with a piece of content 14, the idle mode 10 may incorporate such collected information into future presentations of such content 14. For example, a collected text annotation may be overlaid on a screen 16 of video or a picture on a screen 16, a collected audio annotation may be auralized concurrently with presentation of a corresponding piece of content 14, a collected video annotation may be displayed in a small sub-display on top of a screen 16 of video or a picture on a screen 16, a collected rating may similarly be overlaid or sub-displayed, a created reference may be displayed in connection with a presented piece of content 14, and the like. In addition or in the alternative, an appropriate icon or other symbol may be displayed to show that an annotation exists, where the icon can be actuated to reveal the annotation if the user so desires. In addition, other media meta-data may be displayed, including a creation date for the piece of content 14, a file name or descriptive name, the creator, and the like.

The collected information in one embodiment of the present invention may be employed by the idle mode 10 to select pieces of content 14 for future presentation. For example, the idle mode 10 may in the future select pieces of content 14 in order from highest to lowest rating. Note, though, that in such a circumstance provision should be made to ensure that non-rated pieces of content 14 are not displayed last. Otherwise, it may be that such non-rated pieces of content 14 are seldom if ever presented and the user never has an opportunity to rate same, either actively or passively. Thus, it may be the case that non-rated pieces of content 14 are displayed even before highly rated pieces of content 14, or that such non-rated pieces of content 14 are interleaved with such highly rated pieces of content 14.

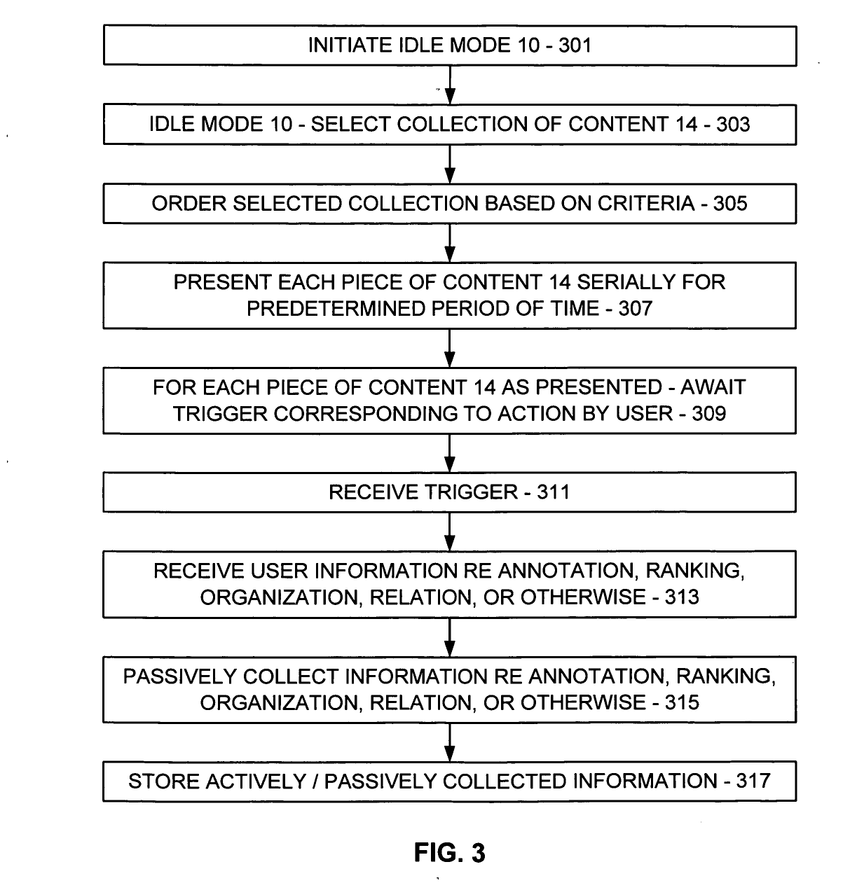

Turning now to FIG. 3, operation of an idle mode 10 on a computing device 12 in accordance with one embodiment of the present invention is shown. As seen, the idle mode 10 initiated either at a user's command or upon some period of inactivity (step 301), and thereafter the idle mode 10 selects a collection of content 14 to be serially presented (step 303). As should be appreciated, such collection to be rendered may be selected based on any appropriate criteria without departing from the spirit and scope of the present invention. For example, the user may have a personal folder with personal digital content 14 therein on the computing device 12 and the idle mode may select all such personal digital content 14 in such personal folder.

Prior to serially presenting such collection of content 14, the idle mode should order same based on an appropriate ordering criteria (step 305). As should also be appreciated, such ordering criteria may be any appropriate criteria without departing from the spirit and scope of the present invention. For example, the ordering may be based on available ratings for each piece of content 14 in the collection, highest to lowest, and may also interleave un-rated pieces of content among the higher-rated pieces of content 14. Each piece of content 14 is then presented for a predetermined period of time (step 307).

During the presentation of a piece of content 14, the idle mode 10 awaits one or more triggers corresponding to some active form of organizing, managing, and categorizing of such piece of content 14 as may be performed by a user of the computing device 12 (step 309). Upon receiving such trigger (step 311), the idle mode 10 receives the corresponding information from the user as appropriate, be it an annotation, a rating, an organization, a relation, or otherwise (step 313). In addition, it may be that idle mode 10 itself passively collects information corresponding to the piece of content 14, be it an annotation, a rating, an organization, a relation, or otherwise (step 315). Thereafter, the idle mode 10 appropriately stores the actively and/or passively collected information with the piece of content 14 and/or elsewhere (step 317).

Of course, at any time should the idle mode 10 detect a trigger that does not correspond to some active form of organizing, managing, and categorizing of such piece of content 14 as may be performed by a user of the computing device 12 as at step 309, but instead corresponds to the user wishing to use the computing device 12, the idle mode 10 ceases. Note that if the idle mode 10 presents the entire collection of content 14 as was selected at step 303, the idle mode 10 may again present the same collection in the same order, may select a new order for the collection as at step 305, or may select a new collection as at step 303.

### CONCLUSION

The present invention may be practiced with regard to any appropriate collection of personal digital content 14 of a user be it local to or remote from a computing device 12, and an idle mode 10 operating on the computing device to present the content 14 or some portion thereof in a serial manner such that the user can annotate, rate, organize, and/or relate the presented content 14 or the like. Significantly, the present invention is not limited to any particular form of action that may be taken with regard to the content 14 by the user, or with regard to the storage location of the content 14. Also significantly, the actions taken may be active and thus purposeful on the part of the user, or passive and thus detected by the idle mode 10 without any purposeful activity on the part of the user. Moreover, such actions may be textual in nature, visual in nature, audible in nature, or the like, and the idle mode 10 includes appropriate functionality to receive and interpret such actions.

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful method and mechanism where a computing device 12 has an idle mode 10 that passively presents personal digital content 14 of a user thereto. The user upon reviewing the content 14 can organize, manage, and categorize same. In particular, the user can annotate, rate, organize, and relate the content 14 as presented. Thus, the content 14 can over time be converted into a highly useful form such that the user can actively and/or passively review same in a more efficient, convenient, and directed manner, and thereby can value the content 14 more highly.

It should be appreciated that changes could be made to the embodiments described above without departing from the inventive concepts thereof. It should be understood, therefore, that this invention is not limited to the particular embodiments disclosed, but it is intended to cover modifications within the spirit and scope of the present invention as defined by the appended claims.

1. A method of implementing an idle mode on a computing device, the idle mode for presenting personal digital content on the computing device in a passive manner to an individual and allowing the individual to manage the presented content, the method comprising the idle mode upon being initiated:
selecting a collection of content to be serially presented;
ordering the selected collection of content based on an ordering criteria; and
presenting each piece of content in the collection in order for a predetermined period of time,
the method further comprising, during the presenting of each piece of content in the collection:
awaiting a trigger from the individual at the computing device corresponding to an active form of managing the piece of content;
receiving such trigger from the individual;
receiving actively collected information corresponding to the trigger from the individual; and
storing the actively collected information.

2. The method of claim 1 comprising the idle mode receiving actively collected information corresponding to the trigger from the individual and comprising an annotation to be included with the piece of content.

3. The method of claim 2 comprising the idle mode receiving an annotation selected from a group consisting of a text annotation, an audible annotation, a visual annotation, an audio-visual annotation, and combinations thereof.

4. The method of claim 1 comprising the idle mode receiving actively collected information corresponding to the trigger from the individual and comprising a rating to be included with the piece of content.

5. The method of claim 4 comprising the idle mode receiving a rating selected from a group consisting of an incremental rating, a decremental rating, a direct rating, and combinations thereof.

6. The method of claim 1 comprising the idle mode receiving actively collected information corresponding to the trigger from the individual and comprising an organization of the piece of content.

7. The method of claim 6 comprising the idle mode receiving the organization of the piece of content selected from a group consisting of an organization of the piece of content within a directory-based system, an organization of the piece of content within a directed-graph-based system, and a combination thereof.

8. The method of claim 1 comprising the idle mode receiving actively collected information corresponding to the trigger from the individual and comprising a relation of the piece of content to other information.

9. The method of claim 8 comprising the idle mode receiving the relation of the piece of content selected from a group consisting of a relation to another piece of content, a relation to an application, a relation to information in a database, and combinations thereof.

10. The method of claim 8 comprising the idle mode receiving the relation of the piece of content to information in a personal organization database that maintains at least one of calendar information for the individual, personal information for other individuals known to the individual, business information for businesses known to the individual, and membership information on memberships of the individual.

11. The method of claim 8 further comprising the idle mode upon receiving the relation creating a reference between the piece of content and the other information.

12. The method of claim 1 further comprising the idle mode detecting a trigger other than a trigger corresponding an active form of managing the piece of content and in response terminating such idle mode.

13. The method of claim 1 further comprising the idle mode during the presenting of each piece of content in the collection passively collecting information corresponding to the piece of content and storing the passively collected information.

14. The method of claim 13 comprising the idle mode passively collecting an annotation to be included with the piece of content.

15. The method of claim 13 comprising the idle mode passively collecting a rating to be included with the piece of content.

16. The method of claim 15 comprising the idle mode passively collecting a rating derived based on other actively collected information received from the individual.

17. The method of claim 13 comprising the idle mode passively collecting an organization of the piece of content.

18. The method of claim 13 comprising the idle mode passively collecting a relation of the piece of content to other information.

19. The method of claim 18 comprising the idle mode passively collecting a relation based on other actively collected information received from the individual.

20. The method of claim 1 further comprising initiating the idle mode by one of a command from the individual and a period of inactivity.

21. The method of claim 1 comprising selecting the collection of content to be serially presented from content available on the computing device.

22. The method of claim 1 wherein at least some of the pieces of content have a corresponding rating, the method comprising the idle mode ordering the selected collection of content based on the rating of each piece of content.

23. The method of claim 22 comprising the idle mode ordering the selected collection of content based on the rating of each piece of content from highest to lowest.

24. The method of claim 23 wherein at least some of the pieces of content have no corresponding rating, the method comprising the idle mode ordering the selected collection of content based on the rating of each rated piece of content from highest to lowest with non-rated pieces of content interleaved therebetween.

25. The method of claim 1 comprising the idle mode awaiting and receiving a trigger selected from a group consisting of a keyboard entry on the computing device, a mouse entry on the computing device, an audible signal at the computing device detected by the idle mode, a visual signal at the computing device detected by the idle mode, and combinations thereof.

26. The method of claim 25 comprising the idle mode awaiting and receiving a trigger selected from a group consisting of an audible signal at the computing device detected by the idle mode and a visual signal at the computing device, and further comprising the idle mode recognizing the individual by way of the trigger and storing with the information an identification of the recognized individual.

27. The method of claim 1 comprising the idle mode receiving the actively collected information as information selected from a group consisting of text information, audible information, visual information, audio-visual information, and combinations thereof.

28. The method of claim 1 further comprising the idle mode including the collected information in a future presentation of the piece of content.

29. The method of claim 1 further comprising the idle mode selecting a future collection of content to be serially presented based at least in part on the collected information.
